(19) United States
(12) Patent Application Publication
(10) Pub. No.: US 2010/0176347 A1
(43) Pub. Date: Jul. 15, 2010

(54) Method Of Limiting The Maximum Stress Developed In A Hybrid Ion-Conducting Ceramic Membrane

(75) Inventors: Nicolas Richet, Fontenay-Le-Fleury (FR); Gilles Lebain, Thiais (FR); Eric Blond, Jargeau (FR); Alain Gasser, Olivet (FR)

Correspondence Address: AIR LIQUIDE USA LLC;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/663,366

(22) PCT Filed: Jun. 11, 2008
(86) PCT No.: PCT/FR08/51041

§ 371 Date: Dec. 7, 2009

(30) Foreign Application Priority Data
Jun. 15, 2007 (FR) 0755793

(51) Int. Cl. C01B 3/38; F17D 1/16

(52) U.S. Cl. 252/373; 137/14

(57) ABSTRACT

A method of limiting the maximum stress developed in a hybrid ion-conducting ceramic membrane, a startup procedure for a reactor containing such a membrane, a shutdown procedure for a reactor containing such a membrane, and a process for producing a syngas implementing said startup and shutdown procedures are provided.

The subjects of the present invention are: a method of limiting the maximum stress developed in a hybrid ion-conducting ceramic membrane; a startup procedure for a reactor containing such a membrane; a shutdown procedure for a reactor containing such a membrane; and a process for producing a syngas implementing said startup and shutdown procedures.

Hybrid ion-conducting ceramic membranes are of great interest for applications in catalytic reactors for the separation of oxygen and for the conversion of hydrocarbons into value-added products, particularly the conversion of methane to a syngas.

Catalytic membrane reactors, called hereinafter CMRs, produced from ceramic materials make it possible to separate oxygen from air by making this oxygen diffuse in ionic form through the ceramic material and by chemically reacting the latter with natural gas (mainly methane) on catalytic sites (particles of Ni or noble metals) deposited on the surface of the membrane. Conversion of the syngas to a liquid fuel by the GTL (gas to liquid) process requires an H₂/CO molar ratio of 2. Now, this ratio of 2 can be obtained directly by a process employing a CMR.

However, ceramic membranes are by nature brittle materials which can withstand only very small deformations, and have a very low ductility compared with metals.

Now, ceramic membranes are subjected to a number of stresses, in particular temperature gradients and pressure gradients, between the reducing side and the oxidizing side of the membrane, and modifications in the oxygen partial pressure on either side of the membrane.

It has been observed that these various stresses are all the higher when the ceramic membrane is in a transient phase, i.e. in an off-equilibrium state between two stable states. Thus, for example, the ceramic membranes employed in a CMR are prestressed mainly during transient phases, particularly during the CMR startup and shutdown phases.

The term “maximum stress” is understood to mean the highest stress that develops in the material, the term “oxidizing side” is understood to mean that surface of the membrane exposed to the highest oxygen partial pressure and the term “reducing side” is understood to mean that surface of the membrane exposed to the lowest oxygen partial pressure.

Hybrid ion-conducting ceramic membranes have the particular feature when they are subjected to an oxygen partial pressure difference of letting O⁻₂ ions pass through them by an ion vacancy diffusion mechanism in the crystal lattice of the ceramic. The diffusion of oxygen results in a deformation of the crystal unit cell, hereafter called chemical expansion.

However, the gradients (in temperature, oxygen vacancy concentration etc.) to which the membrane is subjected may result in different types of behavior and may be the source of stresses possibly leading to destruction of the membrane.

In addition, it is known that the dimensions of the ion-conducting ceramic membrane change when it is subjected to temperature changes. The dimensional change is then referred to as thermal expansion.

Thus, it appears that it is very important, for obvious reliability and safety reasons, to control the chemical and thermal expansions.

One solution envisioned for limiting the expansions of the membrane is to use the creep of the material for relaxing the stresses that may develop in the material. Creep is the deformation of a material subjected to a constant stress. In the case of ion-conducting ceramics, this phenomenon takes place at high temperature. The stresses associated with chemical and thermal deformations are relaxed by allowing the material to accommodate these deformations by creeping. The level of stress in the material decreases over the course of time until it reaches a level compatible with a new modification in the operating conditions, leading to new deformations and new stresses.

However, this solution damages the membrane when subjected to repeated stresses, corresponding to each modification of an operating parameter. The membrane therefore suffers damage characterized not by fracture of the part but by reduction in the lifetime of the membrane.

Consequently, the problem that arises is how to provide an improved method of limiting the maximum stress developed in a hybrid ion-conducting ceramic membrane.

One solution of the invention is therefore a method of limiting the maximum stress developed in a hybrid ion-conducting ceramic membrane subjected, during a transient phase, to a chemical and/or thermal stress on the oxidizing and/or reducing face of the membrane, characterized in that said method comprises controlling the chemical stress on at least one of said faces of the membrane by varying the rate of modification of the oxygen partial pressure on the oxidizing and/or reducing side of the membrane and by varying the rate of modification of the total pressure gradient between the reducing side and the oxidizing side of the membrane, and/or controlling the thermal stress by varying the rate of modification of the thermal gradient at the surface of the membrane.

The term “transient phase” is understood to mean an off-equilibrium period between two stable periods. During this transient phase, the temperature and/or the atmosphere on the oxidizing side and/or reducing side of the membrane vary/varies.

Depending on the case, the method according to the invention may have one of the following features:
the rate of modification of the oxygen partial pressure on the oxidizing and/or reducing side is controlled by:
   (a) bringing a first gas mixture containing oxygen, preferably an N₂/O₂ mixture, into contact with the oxidizing side of the membrane and/or by bringing a second gas mixture containing CH₄ and/or H₂O, preferably an N₂/CH₄ mixture, into contact with the reducing side of the membrane; or
   (b) bringing an inert third gas mixture into contact with the oxidizing and/or reducing side of the membrane, after which oxygen may or may not be brought into contact therewith; the term “inert gas mixture” is understood to mean the gas mixtures which do not react either with the other gases present on the oxidizing and reducing side, or with the ceramic membrane, and/or
   (c) varying, preferably continuously, the rates of enrichment with said gas mixtures and with oxygen and varying the rates of modification of the compositions of said gas mixtures;
the rate of modification of the total pressure gradient between the reducing side and the oxidizing side of the membrane is controlled by:
   (a) bringing a first gas mixture containing oxygen, preferably an N₂/O₂ mixture, into contact with the oxidizing side of the membrane and/or by bringing a second gas mixture containing CH₄ and/or H₂O, preferably an N₂/CH₄ mixture, into contact with the reducing side of the membrane; and
   (b) bringing an inert third gas mixture into contact with the oxidizing and/or reducing side of the membrane, after which oxygen may or may not be brought into contact therewith; and/or
   (c) varying, preferably continuously, the rates of enrichment with said gas mixtures and with oxygen and varying the rates of modification of the compositions of said gas mixtures; in the case of a tubular membrane, it is preferable to have the highest pressure on the outside of the tube;
the rate of modification of the temperature gradient along the membrane is controlled by:
   (a) varying, preferably continuously, the temperature of the gas mixtures introduced at the oxidizing or reducing side of the membrane; and/or
   (b) varying, preferably continuously, the temperature of a heating element external to the membrane;
the ceramic membrane comprises a composite comprising:
at least 75% by volume of a hybrid conducting compound, which conducts electrons and O₂⁻ oxygen anions, said compound being chosen from doped ceramic oxides which, at the operating temperature, are in the form of a perovskite phase; and
0 to 25% by volume of a blocking compound, which differs from the conducting compound, chosen from ceramic materials, of oxide or non-oxide type, metals, metal alloys and mixtures of these various types of materials;
the first gas mixture is air and the second gas mixture is composed of natural gas and steam; and
the ceramic membrane is in the form of a tube.

The invention also relates to a startup procedure for a reactor containing a hybrid ion-conducting ceramic membrane, comprising the steps of:

(a) determining the Young's modulus, the breaking stress and the toughness of said membrane;
(b) determining the maximum stress as a function of the rate of modification of the oxygen partial pressure on the reducing side and/or the oxidizing side, as a function of the rate of modification of the total pressure gradient between the oxidizing side and the reducing side of the membrane and as a function of the rate of modification of the temperature gradient at the surface of the membrane;
(c) comparing the maximum stress with the tensile stress measured at step a); and
(d) introducing the first and second gas mixtures in such a way that the maximum stress of the membrane is maintained below the breaking stress at each instant of this step (d) by employing a method of limiting the maximum stress of the membrane according to the invention.

The startup procedure may be characterized in that between steps (a) and (c), the membrane is heated up to the minimum temperature above which the membrane may undergo at any point a chemical deformation, by maintaining, on either side thereof, an identical oxygen partial pressure, preferably corresponding to the oxygen partial pressure used during the final phases of the procedure for producing said membrane.

The invention also relates to a shutdown procedure for a reactor containing a hybrid ion-conducting ceramic membrane, comprising the steps of:

(a) determining the Young's modulus, the breaking stress and the toughness of said membrane;
(b) determining the maximum stress as a function of the rate of modification of the oxygen partial pressure on the reducing side and/or the oxidizing side, as a function of the rate of modification of the total pressure gradient between the oxidizing side and the reducing side of the membrane and as a function of the rate of modification of the temperature gradient at the surface of the membrane;
(c) comparing the maximum stress with the tensile stress measured at step a); and
(d) introducing the third gas mixture on the reducing side and/or oxidizing side optionally followed by introducing oxygen on the reducing side until an identical atmosphere is obtained on either side of the membrane in such a way that the maximum stress of the membrane is maintained below the breaking stress at each instant of this step (d) by employing a method of limiting the maximum stress of the membrane according to the invention.

Finally, the present invention also relates to a process for producing a syngas containing hydrogen and carbon monoxide, carrying out:
a step (i) of prereforming a hydrocarbon mixture; and
a step (ii) of reforming the hydrocarbon mixture resulting from step (i), in a catalytic membrane reactor (CMR),
   characterized in that, in step (ii), said catalytic reactor is started up by implementing one of the startup procedures according to the invention and/or said catalytic reactor is shut down by implementing the shutdown procedure according to the invention.

The invention will now be described in greater detail.

In the startup or shutdown procedures, the mechanical properties of the membrane, i.e. the Young's modulus, the breaking stress and the toughness, are measured at room temperature and at several intermediate temperatures between 20° C. and the operating temperature of the membrane.

The chemical expansion effect caused by ion transfer is comparable to the thermal expansion effect caused by heat transfer. In both cases, diffuse transfer (of heat/ions) leads to a deformation of the crystal lattice that produces a macroscopic deformation. This chemical/thermal deformation then adds to the mechanical deformation. The analogy between the two effects has therefore been used to develop the notion of chemical shock and to adapt the thermal shock criteria.

Just as for the thermal deformation, the starting postulate is the existence of a direct relationship between the oxygen partial pressure (an intensive state variable, varying by diffusion and therefore equivalent to temperature) and the chemical expansion. In general, this relationship may be expressed in the following form:

ε_{c}=η(P−P₀)

where ε_{c} is the chemical deformation, P is the partial pressure (in the sense of activity) at the point in question, P₀ is a reference partial pressure and η is the chemical expansion coefficient. According to available data and the “chemical” dilatometric behavior of the material in question, a more appropriate expression may be:

$${ɛ}_{c} = a ln ( \frac{P}{{P}_{0}} )$$

where a may be interpreted as a chemical expansion coefficient. This type of law seems appropriate for T and G ion-conducting materials. For the purpose of carrying out a numerical simulation in a transient regime, it is judicious to describe the chemical expansion by a simple law, with two slopes, having coefficients that can be easily interpreted and identified directly from the atmosphere/deformation experimental curve, namely:

ε_{c}=βP+ε₀.

The relationship between chemical expansion and oxygen patial pressure is then described by two straight lines, these being entirely defined by three variables:
Pᵣ, the partial pressure at the break in slope;
β, the chemical expansion coefficient for high partial pressures; and
ε₀, the “instantaneous” chemical expansion.

The chemical expansion law becomes:

$$\{ \begin{matrix}∀ ( {P}_{{O}_{2}} \geq {P}_{r} ) & {ɛ}_{c} = - β {P}_{{O}_{2}} - {ɛ}_{0} \\ ∀ ( {P}_{{O}_{2}} \leq {P}_{r} ) & {ɛ}_{c} = {aP}_{{O}_{2}}\end{matrix} \\ where \\ a = - \frac{β {P}_{r} + {ɛ}_{0}}{{P}_{r}} .$$

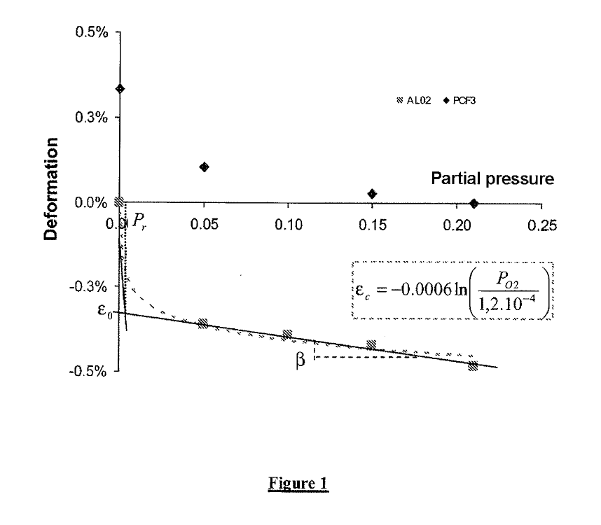

The above two models are illustrated in FIG. 1 showing the experimental chemical expansion results for two ion-conducting materials, the production treatments of which were carried out in nitrogen (material 1) and in air (material 2).

The ceramic is assumed to be homogeneous and isotropic and its thermoelastic behavior is assumed to be linear. The existence of chemical expansion does not modify this behavior—only the expression for the total deformation has to be modified:

ε=εₑ+ε_{T}+ε_{c},

where ε is the total deformation tensor, εₑ is the elastic deformation tensor, ε_{T} is the thermal deformation tensor and ε_{c} is the chemical expansion tensor. Conventionally, the thermal deformation is defined by:

ε_{T}=α(T−T₀)I,

in which α is the secant linear thermal expansion coefficient, T₀ is a reference temperature and I is the identity tensor. Just as conventionally, the elastic deformation tensor is related to the stress tensor σ by:

σ=Kεₑ,

in which K is the Hooke tensor.

This model of the thermomechanical behavior is then implemented in a finite-element computation code, for example the ABAQUS code. The simulation takes place in three steps:
(i) thermal simulation using, as load, the surface temperatures resulting from simulations and/or measurements, so as to obtain the temperatures at any point and at each instant in the membrane;
(ii) use of the temperature field resulting from the above calculation as input data for simulating the diffusion of oxygen through the membrane; and
(iii) use of the temperature and partial pressure fields as input data for the thermomechanical simulation.

The calculation (step 2) of the oxygen diffusion through the membrane requires Wagner's law to be implemented. It is worthwhile pointing out that steps 1, 2 and 3 may also be carried out simultaneously in a coupled calculation. FIG. 2 illustrates the decoupled calculation procedure, which is simpler to implement and just as effective.

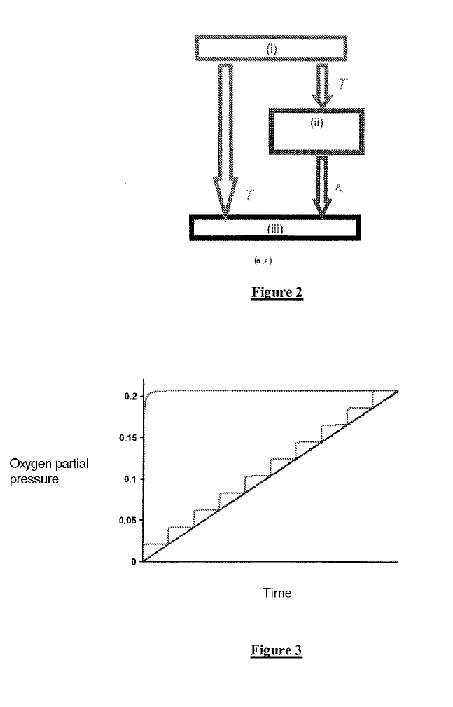

In step 2, it is possible to vary the laws of variation of the atmosphere so as to test various production unit startup laws. The particular case of a tubular membrane under uniform temperature conditions is shown in FIG. 3. The curve at the bottom represents a linear oxygen partial pressure variation profile, the curve in the middle represents a stepwise oxygen partial pressure variation profile and the curve at the top represents a “very rapid” oxygen partial pressure variation profile.

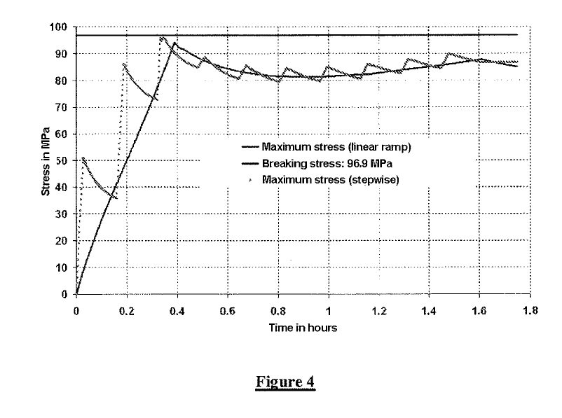

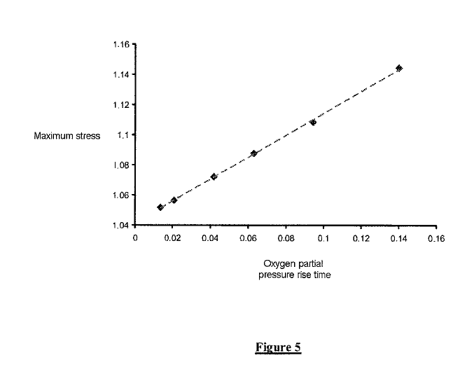

FIG. 4 shows the change in the maximum stress on the membrane according to the oxygen partial pressure variation profile. The oxygen partial pressure variation profiles in question correspond to the profiles shown in FIG. 3. Thus, the straight line at the top represents the breaking stress. The curve in the middle represents the maximum stress for a stepwise variation in the oxygen partial pressure and the curve at the bottom represents the maximum stress for a linear variation in the oxygen partial pressure.

Thus, a linear variation in the oxygen partial pressures results in a lower maximum stress level than an almost instantaneous rise. It may also be seen that a stepwise loading produces stress intensity peaks.

The results of the calculations also show that a continuous variation in the operating parameters is preferable. Overall, it is the average rate of rise which is influential. As may be seen in FIG. 4, for this material a linear rise in time produces a much lower maximum stress than a sudden change or a stepwise change.

The change in maximum stress in the steady state (located on the internal face of the tube) as a function of the oxygen partial pressure rise time inside the tube (linear ramp) is shown in FIG. 5. It is therefore possible, knowing the breaking stress of the membrane, to define the maximum rate of change of atmosphere that guarantees integrity of the structure.

This method makes it possible to establish, by simulation, a maximum stress/rate of change of atmosphere chart that helps in the running of the reactor for the purpose of guaranteeing its mechanical integrity. This method can be transposed to any type of geometry (by finite-element modeling) and to all grades of materials (by identifying the appropriate parameters).

1-11. (canceled)

12. A method of limiting the maximum stress developed in a hybrid ion-conducting ceramic membrane subjected, during a transient phase, to a chemical and/or thermal stress on the oxidizing and/or reducing face of the membrane, comprising at least one of;
a) controlling the chemical stress on at least one of said faces of the membrane by varying the rate of modification of the oxygen partial pressure on the oxidizing and/or reducing side of the membrane
b) varying the rate of modification of the total pressure gradient between the reducing side and the oxidizing side of the membrane,
c) controlling the thermal stress by varying the rate of modification of the thermal gradient at the surface of the membrane.

13. The method of claim 12, wherein the rate of modification of the oxygen partial pressure on the oxidizing and/or reducing side is controlled by at least one of;
a) bringing a first gas mixture containing oxygen into contact with the oxidizing side of the membrane;
b) bringing a second gas mixture containing CH₄ and/or H₂O into contact with the reducing side of the membrane;
c) bringing an inert third gas mixture into contact with the oxidizing and/or reducing side of the membrane
d) varying the rates of enrichment with said gas mixtures and with oxygen and varying the rates of modification of the compositions of said gas mixtures.

14. The method of claim 13, wherein the first gas mixture contains a N₂/O₂ mixture.

15. The method of claim 13, wherein the second gas mixture contains a N₂/CH₄ mixture.

16. The method of claim 13, wherein the oxidizing side of the membrane is brought into contact with oxygen after having contacted the inert third gas mixture.

17. The method of claim 13, wherein the oxidizing side of the membrane is not brought into contact with oxygen after having contacted the inert third gas mixture.

18. The method of claim 13, wherein the reducing side of the membrane is brought into contact with oxygen after having contacted the inert third gas mixture.

19. The method of claim 13, wherein the reducing side of the membrane is not brought into contact with oxygen after having contacted the inert third gas mixture.

20. The method of claim 13, wherein the rates of enrichment with said gas mixtures and with oxygen and the rates of modification of the compositions of said gas mixtures are varied continuously.

21. The method of claim 12, wherein the rate of modification of the total pressure gradient between the reducing side and the oxidizing side of the membrane is controlled by:
a) bringing a first gas mixture containing oxygen into contact with the oxidizing side of the membrane;
b) bringing a second gas mixture containing CH₄ and/or H₂O into contact with the reducing side of the membrane;
c) bringing an inert third gas mixture into contact with the oxidizing and/or reducing side of the membrane,
d) varying the rates of enrichment with said gas mixtures and with oxygen and varying the rates of modification of the compositions of said gas mixtures.

22. The method of claim 21, wherein the first gas mixture contains a N₂/O₂ mixture.

23. The method of claim 21, wherein the second gas mixture contains a N₂/O₂ mixture.

24. The method of claim 21, wherein the rates of enrichment with said gas mixtures and with oxygen and the rates of modification of the compositions of said gas mixtures are varied continuously.

25. The method of claim 21 wherein the oxidizing side of the membrane is brought into contact with oxygen after having contacted the inert third gas mixture.

26. The method of claim 21, wherein the oxidizing side of the membrane is not brought into contact with oxygen after having contacted the inert third gas mixture.

27. The method of claim 21, wherein the reducing side of the membrane is brought into contact with oxygen after having contacted the inert third gas mixture.

28. The method of claim 21, wherein the reducing side of the membrane is not brought into contact with oxygen after having contacted the inert third gas mixture.

29. The method of claim 12, wherein the rate of modification of the temperature gradient along the membrane is controlled by performing at least one of:
a) varying the temperature of the gas mixtures brought into contact with the oxidizing or reducing side of the membrane;
b) varying the temperature of a heating element external to the membrane.

30. The method of claim 29, wherein the temperature of the gas mixtures brought into contact with the oxidizing or reducing side of the membrane is varied continuously.

31. The method of claim 29, wherein the temperature of a heating element external to the membrane is varied continuously.

32. The method of claim 12, wherein the ceramic membrane comprises a composite comprising:
a) at least 75% by volume of a hybrid conducting compound, which conducts electrons and O₂⁻ oxygen anions, said compound being chosen from doped ceramic oxides which, at the operating temperature, are in the form of a perovskite phase; and
b) 0 to 25% by volume of a blocking compound, which differs from the conducting compound, chosen from ceramic materials, of oxide or non-oxide type, metals, metal alloys and mixtures of these various types of materials.

33. The method of claim 12, wherein the first gas mixture is air and the second gas mixture is composed of natural gas and steam.

34. The method of claim 12, wherein the ceramic membrane is in the form of a tube.

35. A startup procedure for a reactor containing a hybrid ion-conducting ceramic membrane, comprising the steps of:
a) determining the Young's modulus, the breaking stress and the toughness of said membrane;
b) determining the maximum stress as a function of the rate of modification of the oxygen partial pressure on the reducing side and/or the oxidizing side, as a function of the rate of modification of the total pressure gradient between the oxidizing side and the reducing side of the membrane and as a function of the rate of modification of the temperature gradient at the surface of the membrane;
c) comparing the maximum stress with the tensile stress measured at step a); and
d) introducing the first and second gas mixtures in such a way that the maximum stress of the membrane is maintained below the breaking stress at each instant of this step (d) by employing a method of limiting the maximum stress of the membrane as claimed in claim 12.

36. The procedure of claim 35, wherein between steps (a) and (c), the membrane is heated up to the minimum temperature above which the membrane may undergo at any point a chemical deformation, by maintaining, on either side thereof, an identical oxygen partial pressure,

37. The procedure of claim 36, wherein the oxygen partial pressure corresponds to the oxygen partial pressure used during the final phases of producing said membrane.

38. A shutdown procedure for a reactor containing a hybrid ion-conducting ceramic membrane, comprising the steps of:
a) determining the Young's modulus, the breaking stress and the toughness of said membrane;
b) determining the maximum stress as a function of the rate of modification of the oxygen partial pressure on the reducing side and/or the oxidizing side, as a function of the rate of modification of the total pressure gradient between the oxidizing side and the reducing side of the membrane and as a function of the rate of modification of the temperature gradient at the surface of the membrane;
c) comparing the maximum stress with the tensile stress measured at step a); and
d) introducing the third gas mixture on the reducing side and/or oxidizing side optionally followed by introducing oxygen on the reducing side until an identical atmosphere is obtained on either side of the membrane in such a way that the maximum stress of the membrane is maintained below the breaking stress at each instant of this step (d) by employing a method of limiting the maximum stress of the membrane as claimed in claim 12.

39. A process for producing a syngas containing hydrogen and carbon monoxide, carrying out:
a step (i) of prereforming a hydrocarbon mixture; and
a step (ii) of reforming the hydrocarbon mixture resulting from step (i), in a catalytic membrane reactor (CMR),
wherein, in step (ii), said catalytic reactor is started up by implementing one of the startup procedures as claimed in claim 35 and/or said catalytic reactor is shut down by implementing the shutdown procedure as claimed in claim 38.
